(19) United States
(12) Patent Application Publication
(10) Pub. No.: US 2023/0256279 A1
(43) Pub. Date: Aug. 17, 2023

(54) FIRE SUPPRESSANT MATERIAL

(71) Applicant: NewSouth Innovations Pty Limited, Sydney, New South Wales (AU)

(72) Inventors: Richard Mark Pashley, Cook, Australian Capital Territory (AU); Mohammad Ziaee, Sydney, New South Wales (AU)

(21) Appl. No.: 18/001,997

(22) PCT Filed: Jun. 18, 2021
(86) PCT No.: PCT/AU2021/050632

§ 371 Date: Dec. 15, 2022

(30) Foreign Application Priority Data
Jun. 18, 2020 (AU) 2020902021

(51) Int. Cl. A62D 1/00; B01J 20/18; B01J 20/28; B01J 20/34

(52) U.S. Cl. CPC A62D 1/0014; B01J 20/18; B01J 20/3408; B01J 20/3483; B01J 20/28016

(57) ABSTRACT

Disclosed is a fire suppressant material for controlling or extinguishing a combustion process, the fire suppressant material comprising zeolite particles with an internal porous structure, wherein molecules of a fire extinguishing substance are contained within the internal porous structure of the zeolite material.

### TECHNICAL FIELD OF THE INVENTION

The present disclosure relates to fire suppressant materials and methods of use, and in particular to the use of nanotechnology to enable the use of a sustainable and environment friendly fire suppressant material to combat fires. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Bushfire is a major concern in Australia and many other countries. Climate change adds to the frequency of bushfires due to global warming. Longer, hotter and more intense heatwaves, and more frequent and severe droughts, are driving up the likelihood of very high bushfire risk, particularly in the southwest and southeast of Australia and North America. The latest bushfire in Australia burnt through hundreds of thousands of hectares, 630 homes and the loss of six lives, with costs approaching $100 billion.

Conventional methods of eliminating bushfire have been limited to reactive methods such as full-scale deployment of fire department and state emergency services. Dropping water from airplanes and directly from appliance hoses is an inefficient method of stopping raging fires. This method is also dangerous, as shown in the recent bushfires in Australia. Water runs down houses and trees to the ground and so must be continuously replenished to be effective, especially against ember attack -which is the most damaging mechanism for wildfire propagation. Furthermore, a typical house fire requires over 10 tons of water, which itself causes extensive damage. Continuous rain finally extinguished the recent bushfires in NSW.

Fire retardant coatings are another method used widely in building construction to delay the spread of fire. Fire retardant coatings are mainly involved for reaction-to-fire to retard or inhibit the combustion of flammable materials (wood, foam, textile fabrics, electric cables, and fibre reinforced composites). Therefore, it is beneficial if coatings do not contribute a significant amount of fuel to the fire and, at the same time, limit the flame spread and smoke development. Fire retardant coating is one of the easiest, oldest, and most efficient ways to protect the materials against fire. This approach does not cause chemical modification of the substrate, but rather the formation of a protective layer which may alter the heat flux to the substrate and may inhibit its thermal degradation, ignition, or combustion. It is beneficial if fire-retardant coatings have minimum flame spread, negligible or low release of smoke and/or toxic gases, are easy to apply, show good wear resistance, adhere to the underlying substrate and offer low cost. Different test parameters, such as oxygen index (OI), flame spread rate, ignition time, heat intensity, smoke generation, and release of toxic gases, are to be considered for assessing the flammable materials.

Fire retardants are key components used in reducing the effect of fire on people, property, and the environment. The most common elements used as flame retardants are bromine, chlorine, phosphorous, and aluminium (aluminium hydroxide is also used as a fire retardant) . Compounds of these elements are added to or treat potentially flammable materials. Fire retardants stop the fire by interacting with the fire cycle in the gaseous phase and stop the chemical chain reaction. Fire retardant coatings look like architectural paints and are mainly available in solvent form and are applied by conventional methods, brush, roller, and spray. Although protection of materials against fire by the use of coatings for indefinite periods is impossible, it can delay the spread of fire or keep a structure intact against fire, thereby allowing sufficient time for safety measures to be taken.

Almost all fire-retardant additives work by imposing a layer of less flammable materials onto a flammable surface such as wood. An example such as Teknos fire retardant coating will swell under heat to form a multicellular charred layer, which acts as an insulating barrier and slows heat and mass transfer between the condensed and vapor phases.

Fire retardant gels are also used in the market to provide fire protection. An example of such is Thermo Gel fire retardant that can be sprayed on to homes, cars and surrounding grass to provide a 7 hours barrier from bushfire. The Thermo Gel contains polymer that can be hydrolysed with water and absorbs the water to form gel. This works in much the same way that polymers in baby’s nappies work. The polymer is sprayed with water onto walls and other surfaces to be protected in the event of bushfire. It has a life of seven hours from application and can be re-wetted by misting water over the coatings. Once there is no more fire danger, the Thermo Gel coating can be removed by spraying water over the surface. However, there are deficiencies with the use of Thermo-Gel, such as the need to apply it just prior to or during a fire, and that it will be washed away over time and with rain, etc.

It is an object of the present invention to overcome or ameliorate one or more the disadvantages of the prior art, or at least to provide a useful alternative.

It is an object of at least one preferred embodiment of the present invention to provide a fire suppressant material for controlling or extinguishing a combustion process that provides at least one of the following advantages: the fire suppressant material is non-toxic, is readily available, can be used in a number of applications, is highly efficient at suppressing a fire in a relatively short period of time, and does not require the use of copious amounts of water.

### SUMMARY OF THE INVENTION

Disclosed is a fire suppressant material for controlling or extinguishing a combustion process, the fire suppressant material comprising zeolite particles with an internal porous structure, wherein molecules of a fire extinguishing or prevention substance are contained within the internal porous structure of the zeolite material.

In one aspect of the invention, the fire suppressant material comprises zeolite 5A particles. In another aspect of the invention, the fire suppressant material comprises zeolite 3A or 4A particles. In another aspect of the invention, the fire suppressant material comprises a combination of zeolite 5A and zeolite 3A or 4A particles.

The fire suppressant material of the invention enables the release of significant amounts of the fire extinguishing substance when a fire incident occurs. The fire extinguishing substance is released in the form of a gas thus creating a barrier to oxygen and extinguishing, or substantially extinguishing, or at least suppressing the fire locally.

The advantages of the present invention are many, for example; the invention avoids the use of water to extinguish a fire (water is not particularly efficient at extinguishing fire); because no water is used, there can be no water damage to the structure being extinguished; use of CO₂ or water vapour is an efficient way of putting out and suppressing a fire; the invention provides an efficient delivery mechanism of a fire extinguishing substance; the fire suppressant material of the invention works at low temperatures, which is in contrast to other fire suppressant materials in the prior art. Furthermore, this fire suppressant material of the invention is non-toxic, is readily available, can be used in a number of applications, and is highly efficient at suppressing a fire in a short period of time.

In some forms of the invention, the molecules of the fire extinguishing substance may be molecules of carbon dioxide or water or any alternative fire extinguishing substance. Carbon dioxide is a cheap and effective fire extinguishing substance that can help smother a fire by blocking access to oxygen, which is one of the three required substances (the other two being fuel and heat) to start and sustain a combustion process. Water is another cheap and environmentally friendly substance which can assist in the removal of the generated heat and thus control a combustion process.

In some forms of the invention, the zeolite particles may be configured to preferentially absorb molecules of either carbon dioxide or water over molecules of nitrogen or oxygen. Nitrogen gas is lighter compared to carbon dioxide or water and hence may not be able to provide as effective a protection as that afforded by either carbon dioxide or water. Although it will be appreciated that, under some circumstances, nitrogen would still provide an effective extinguishing substance. It will also be appreciated that absorption and release of oxygen will defeat the intended purpose of extinguishing a fire, as it is one of the primary components that initiates and sustains a combustion process.

In some forms of the invention, the pores of the internal porous structures of the zeolite particles are substantially consistent in size and shape. This ensures that the selectivity of the pores is maintained to the desired molecules of the fire extinguishing substance.

In some forms of the invention, the fire suppressant material may be configured or adapted to activate and release the molecules of the fire extinguishing substance upon absorption or exposure to the heat generated in the combustion process. Such heat absorption process deprives the combustion process of the heat required to sustain itself, effectively acting as a heat sink.

In some forms of the invention, activation of the fire suppressant material to release the fire extinguishing substance occurs at a relatively low temperature range of up to 80° C. In some forms of the invention, that activation may occur at any temperature above 80° C., and in some forms of the invention, activation may occur at or below 200 or 300° C. It will be appreciated that the fire extinguishing substance can be delivered or substantially delivered at a predetermined temperature, or temperature range, by selection of the fire suppressant material and the fire suppressant it delivers. Additionally, the present invention provides, for the first time, the possibility of delivering a fire extinguishing substance in a staged extinguishing method, whereby a specific fire extinguishing substance can be released from the fire suppressant material at a predetermined temperature (or temperature range), and a different fire extinguishing substance can be released from the fire suppressant material at a different predetermined temperature (or temperature range).

Such a low activation temperature in turn results in the suppression of ignition of various materials (e.g. paper ignites at a temperature of 233° C.). Such a feature enables the fire suppressant material to be employed to prevent bushfire damage and transmission through ember attack, which is known to be an important mechanism of bushfire propagation. For example, the activation may occur at a temperature of up to about 80, 90, 100, 110, 120, 130, 140, 150, 160, 170, 180, 190, or 200° C. The activation may occur at a temperature between about 80-90, 90-100, 100-110, 110-120, 120-130, 130-140, 140-150, 150-160, 160-170, 170-180, 180-190, or 190-200, 200-210, 210-220, 220-230, 230-240, 240-250, 250-260, 260-270, 270-280, 280-290, 290-300° C.

In some forms of the invention, the fire suppressant material may be configured or adapted such that its activation upon absorption of heat results in a release of a volume of molecules of an extinguishing substance that is 100 - 200X greater than the volume of the fire suppressant material (i.e., zeolite). The release of such a large volume of fire extinguishing substance (in the form of fire extinguishing gas) on absorption of heat has multiple effects in absorbing heat and blocking access to oxygen which act to extinguish a fire locally.

In some forms of the invention, the fire suppressant material may be capable of being regenerated on exposure to the atmosphere, or a source of the fire extinguishing substance after use. The carbon dioxide (or water vapor) molecules present in the atmosphere may be reabsorbed into the pores of the zeolite particles. This provides a cheap and environmentally friendly method to regenerate the fire suppressant material. Similarly, industrial flue gases which typically contain carbon dioxide or water vapor could also be employed as sources to regenerate the fire suppressant material.

In another aspect of the invention, a product for protecting a surface from a combustion process is provided, the product comprising the fire suppressant material as set forth above.

In another aspect of the invention, a method for protecting a surface from a combustion process is provided, the method comprising the step of: depositing a protective material onto the surface, the protective material comprising a fire suppressant material comprising zeolite particles having an internal porous structure and having molecules of fire extinguishing substance contained in the internal porous structure of the zeolite particles.

In some forms of the invention, the zeolite particles may be dispersed or suspended in a solvent. This will advantageously enable the fire suppressant material of the invention to be mixed with polymeric materials and deposited on a surface in order to form a protective coating on the surface. For example, this coating may be used on combustible cladding which is present on high rise buildings.

In some forms of the invention, the method comprises the step of dispersing fire suppressant material comprising zeolite particles in a solvent. This will ensure mixing of the zeolite particles in a uniform manner with the other components of the protective coating, such as polymers.

In some forms of the invention, a method for improving a fire suppressant system is provided, the method comprising the step of: adding a fire suppressant material as set forth above to a direct fire suppressant system. It will be appreciated that this embodiment of the invention will improve the ability of existing direct fire suppressant systems to combat fires.

In another aspect of the invention, a method of directly suppressing a fire by applying the fire suppressant material disclosed herein to the fire is provided. In another aspect of the invention, the fire suppressant material disclosed herein is applied using a CO₂ piston or fire-fighting cannon. In another aspect of the invention, the fire suppressant material of the invention is dropped from a plane onto a fire.

In another aspect of the invention, the fire suppressant material of the invention can be used to form a barrier against fire. In another aspect of the invention, a method of forming a barrier against fire is provided, the method comprising the step of: applying the fire suppressant material of the invention to the area where a barrier against fire is needed. In some preferred embodiments, the fire suppressant material of the invention can be delivered as-is to the site of a fire, or as a prevention measure in the event that a fire occurs at that site. In other preferred embodiments, the fire suppressant material of the invention can be contained in a sealed container, which preferably contains the fire extinguishing substance in gaseous or liquid form within the sealed container. In this embodiment, the container can be adapted to break apart on the exposure to heat, light or water, thereby substantially releasing the fire suppressant material and in turn releasing the fire extinguishing substance. In other preferred embodiments, the particles of fire suppressant material can be individually coated to protect the fire suppressant material and/or prevent inadvertent release of the fire extinguishing substance. For example, a surface coating can be applied to each particle of fire suppressant material, which coating is adapted to melt at low temperatures, say at 80° C.

### Definitions

In describing and claiming the present invention, the following terminology will be used in accordance with the definitions set out below. It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Unless the context clearly requires otherwise, throughout the description and the claims, the terms “comprise”, “‘comprising”, and the like are to be construed in an inclusive sense as opposed to an exclusive or exhaustive sense; that is to say, in the sense of “including, but not limited to”. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of.” In other words, with respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The complete disclosures of the patents, patent documents and publications cited herein are incorporated by reference in their entirety as if each were individually incorporated.

### BRIEF DESCRIPTION OF THE DRAWINGS

Embodiments will now be described by way of example only, with reference to the accompanying drawings in which:

FIG. 1 is a schematic which illustrates one embodiment of a method of using the fire suppressant material of the invention to protect a surface;

FIG. 2 is a representation of the fire suppressant material of the invention in the form of zeolite particles;

FIG. 3 is a scanning electron micrograph of the fire suppressant material of the invention in the form of zeolite particles.

FIG. 4 are photographs of two examples of commercially available zeolites showing the varying shapes and sizes that are manufactured. These examples are in the size range of 1-5 mm.

FIG. 5 demonstrates fire suppressant properties of the fire suppressant material of the invention in the form of zeolite 5A. A piece of burning wood (FIG. 5A) is treated with zeolite 5A particles (in this case by distributing a small quantity over the surface of the burning wood surface) equilibrated with 1 atm CO₂, and totalling ⅒th the weight of the piece of burning wood. This results in the fire being rapidly extinguished (FIG. 5B). The efficacy and speed with which the fire was suppressed and extinguished was a surprising outcome, and was within seconds.

FIGS. 6A and 6B demonstrate the fire suppressant properties of the fire suppressant material of the invention by immediately extinguishing a large burning wooden ember.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

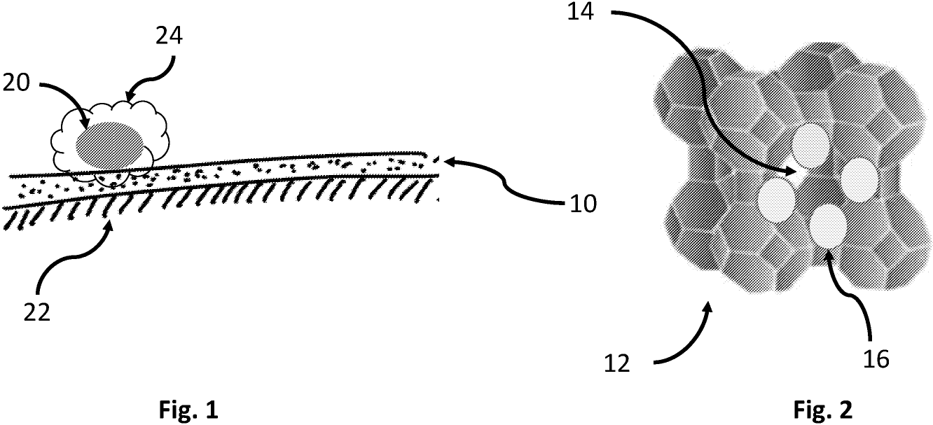

Referring to FIG. 1, the fire suppressant material of the invention 10 (in the form of a coating layer) is shown in use on a substrate 22. Upon activation, the fire suppressant material 10 reduces the available heat and oxygen in order to control or extinguish or suppress a fire or an ember. A well-known method to reduce oxygen availability is to smother a fire with an inert gas, such as carbon dioxide. The disclosed material employs a process of physisorption to store an inert gas until required. Physisorption involves the formation of weak bonds using forces such as for example van der Waals forces between two materials. In this way, a gas molecule may for example be bound to the surface of another material (usually a solid). Physisorption is also a reversible process that can be reversed by the application of sufficient energy to break the bond (usually in the form of heat).

As shown in FIG. 1, the fire suppressant material 10 may be effective in combating ember attack from a bushfire. When located in proximity to an ember 20, the fire suppressant material 10 may absorb the heat from the ember and be activated to release the fire extinguishing substance from the fire suppressant material. In some forms, that fire extinguishing substance comprises carbon dioxide molecules and/or water molecules or alternative extinguishing substances. For example, the release of a large number of carbon dioxide molecules results in the formation of a blanket of carbon dioxide gas 24 around the ember that effectively prevents access to oxygen for the ember to substantially or completely extinguish it. It has been surprisingly found that even if the ember is oxygen-deprived for a short period of time, this is sufficient for the ember to be substantially or completely extinguished. Simultaneously, the absorption of heat by the fire suppressant material 10 from the ember 20 helps to prevent transfer of this heat to the surface 22 (e.g., wood or other combustible materials). In this manner, the heat of the ember 20 is prevented from increasing the temperature of the surface 22 to beyond its ignition temperature (for example the ignition temperature for paper is 233° C.). The combined action of preventing access to oxygen and absorption of heat effectively stops the ember 20 from undergoing further combustion. The efficacy and speed with which the material of the invention is able to suppress and extinguish a fire or an ember was a surprising outcome. A further surprising outcome of the invention is that the fire suppressant material is self-regulating, in the respect that more or less fire extinguishing substance is released depending on the need (i.e., the temperature the fire suppressant material is exposed to). This provides an ability for the fire suppressant material of the invention to have some ‘longevity’ in resisting a fire, in that it only delivers enough fire extinguishing substance that is required. Additionally, different zeolite particles can have different temperature ranges at which they release a fire extinguishing substance, and hence different applications are contemplated herein. It is worth noting that there are around 250 types of zeolite structures which are possible, and selection of the appropriate zeolite is not a straightforward consideration. For example, in order to protect a roof from fires caused by ember/electrical issues, two layers of fire suppressant material with different releasing temperatures could be used in the roof cavity. As an example, a ‘top’ layer could release CO₂ at about 80° C. and if the fire persists, a ‘bottom’ layer would be activated and releases carbon dioxide at a higher temperature.

In order to protect a surface 22 from combustion, the fire suppressant material 10 in some forms is applied and affixed onto the surface 22 to be protected.

Referring now to FIG. 2, disclosed herein is a fire suppressant material comprising zeolite particles 12 having an internal porous structure 14. Molecules of fire extinguishing substance are contained within the internal porous structure of the zeolite particles 12.

The fire suppressant material may be provided in the form of a powder consisting of zeolite particles 12 which may further be dispersed in a solvent together with other materials such as polymer in order to be coated on a variety of surfaces. It will be appreciated that the coating should be formulated such that there is a sufficient amount of the binder to retain the fire suppressant material into a contiguous layer, but not cover or envelop the zeolite particles so as to occlude its porosity. Spraying or other suitable techniques may then be employed to form a coating of the fire suppressant material on the desired surface/object. Example of surfaces that can be protected in this manner include walls, roofs, roof tiles, the surface of internal cavities, and vegetation. In another embodiment of the invention, the fire suppressant material may be sprayed or otherwise deposited onto vegetation such as trees, bushes and grass in front of an approaching fire. In another embodiment of the invention, the fire suppressant material may be sprayed or otherwise deposited directly onto a fire.

Zeolites 12 are microporous, aluminosilicate crystalline minerals widely used as commercial adsorbents and catalysts, which have many different structural forms, and occur both naturally and through manufacturing. The principal raw materials used to manufacture zeolites are silica and alumina, which are among the most common mineral components on earth. Zeolites can confine molecules or ions 16 in small nanopore spaces 14 as shown best in FIG. 2, which causes changes in their structure and reactivity and can give rise to very specific absorption properties. The molecules or ions may be in the form of sodium or potassium or alternative molecules or ions.

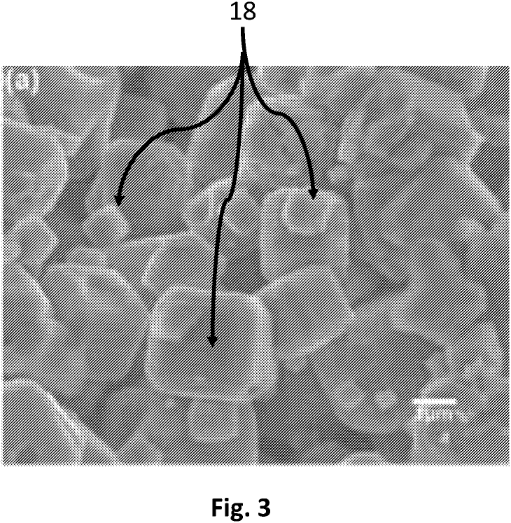

Referring to FIG. 3, an electron micrograph of one embodiment of a fire suppressant material is shown. In this image the fire suppressant material is in the form of selected zeolite particles 18 that have the ability to absorb and store carbon dioxide gas molecules via physisorption into 0.5 nm pores (in 5A zeolite). By carefully selecting the zeolites characteristics (for example composition, structure and porosity), it may be made to absorb a volume of carbon dioxide that may be almost 100 - 200 x greater than the volume of the zeolite itself. The carbon dioxide that is physisorbed (i.e., physically absorbed) in these pores of the zeolite may then be released by the application of heat, which may be transferred from the embers generated from the combustion process. The fire suppressant material of the invention may be tailored in such a way that a temperature of even up to only 80° C. provides heat energy that is sufficient to break the bonds formed between the carbon dioxide and the pore surface and release the molecules of carbon dioxide from the pores.

The fire suppressant material may also be used in many other applications, such as in roof cavities, car insulation and even for coating combustible tower block claddings and coatings. Faulty wiring, including faulty electrical outlets and malfunctioning appliances, is one of the most common causes of house and apartment fires. Cases of such fires are high in months where there is an increase use of lights and heating appliances. In roof fires, light fixtures and electrical wirings in the attic are usually the culprits. Burned wires can start a fire in houses and they are dangerous because they often go unnoticed. Loose electrical connections are the primary cause of burned wires.

The fire extinguishing substance of the fire suppressant material of the invention may comprise carbon dioxide, water molecules or any other extinguishing substance. In the case of water, zeolites have the ability to trap water molecules in their internal pores. Water is a cheap and environmentally friendly option to extinguish fires that is readily available, but usually requires more heat to desorb, and this desorption is slower than for CO₂.

The fire suppressant material of the invention may also have the ability to be regenerated by simply exposing the fire suppressant material to the atmosphere after it has released the entrapped fire extinguishing substance. Carbon dioxide (or water vapor) is freely available in the atmosphere and the zeolites simply need to be exposed to the atmosphere for reabsorption of these gases into the microstructure. Similarly, the fire suppressant material may also be regenerated by exposure to other sources of gaseous carbon dioxide. For example, industrial flue gases generated from the burning of fossil fuels and other similar processes contain significant amounts of carbon dioxide and water vapor. In this sense, the fire suppressant material of the invention can serve to reduce the amount of carbon dioxide released to the atmosphere by burning of fossil fuels.

In a yet further embodiment, the fire suppressant material of the invention can be employed as an additive that improves the effectiveness of direct fire suppressant systems. For example, partially hydrophobic zeolites containing absorbed carbon dioxide molecules may be used to stabilise an air or carbon dioxide foam for use in direct fire suppression. As the foam becomes heated, the heat activates the carbon dioxide (or water molecules) in the internal pores of the zeolite thus releasing large amounts of carbon dioxide. Such a release will support the action of the foam in fire suppression. A wide range of foams can be produced using different mixtures of surfactant, water soluble polymer, electrolytes and zeolite micro-particles. However, foams can be stabilised using nano- and micro-sized particles alone, if they are suitably hydrophobized. These foams can be stable for long periods of time, with a lifetime of months. These particles could be added to the currently available extinguishing foams and the released CO₂ could improve the effectiveness of the ordinary extinguisher foams because it acts as a gas blanket layer (CO₂ is a heavier gas compared with air). Also, use of a natural and biodegradable foaming agent would ensure an environmentally friendly product.

### EXAMPLES

The present invention will now be described with reference to the following examples which should be considered in all respects as illustrative and non-restrictive.

### Example 1

Zeolite or molecular sieve 5A has been used for the absorption of CO₂ from the atmosphere and from pure CO₂ (i.e. 1 atm) emissions, such as from coal fired power stations. This material has uniform nanometer (0.5 nm) size pores ideally suited for the specific absorption of CO₂ molecules.

When exposed to a pressure of 1 atm CO₂ these materials absorb up to about 15% their weight with the emission of heat. This amount of CO₂ can be almost completely re-emitted by heating the material even to only modest temperatures, below about 80° C. in the atmosphere. Given that the zeolite has a density of about 0.7 g/mL, this means that under heated conditions the CO₂ emitted can be up to 100 - 200 x the zeolite volume.

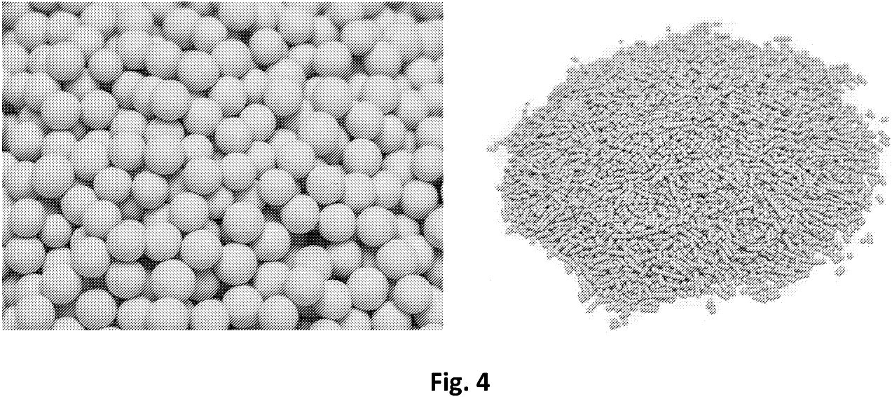

These zeolites are manufactured and produced commercially in a wide range of shapes and sizes as illustrated in FIG. 4.

### Example 2

Generally, thermal conductivity of burnt clay bricks ranges from 0.4 W/mK to 0.7 [W/mK]

By comparison, the thermal conductivity of zeolite depends on temperature, pressure, adsorbed gases, and the saturation percentage. At a pressure of 1 bar, saturated with CO₂, the zeolite thermal conductivity is typically about 0.145 [W/(mK)].

This means in average thermal conductivity of zeolite 5A is 2.75 to 4.8 times less than the thermal conductivity of burnt clay bricks.

These properties suggest that zeolites could be used in roof cavities for fire protection and as suitable insulation material.

### Example 3

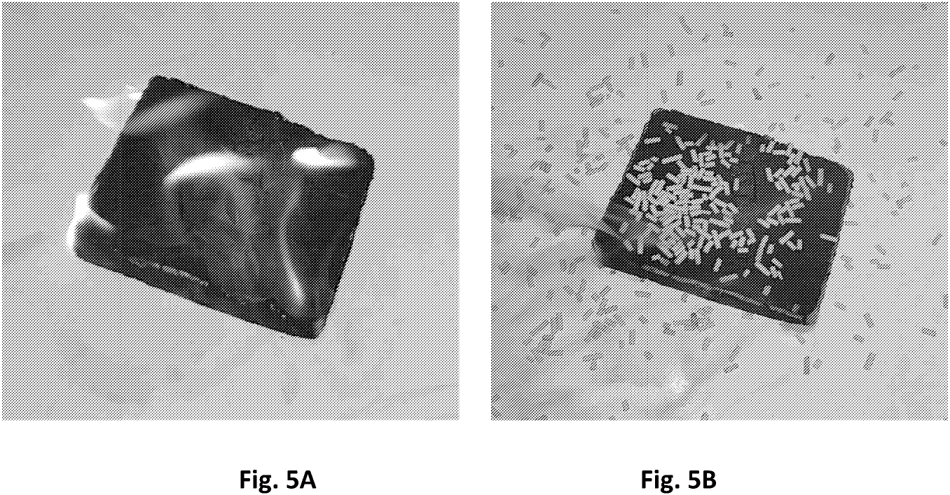

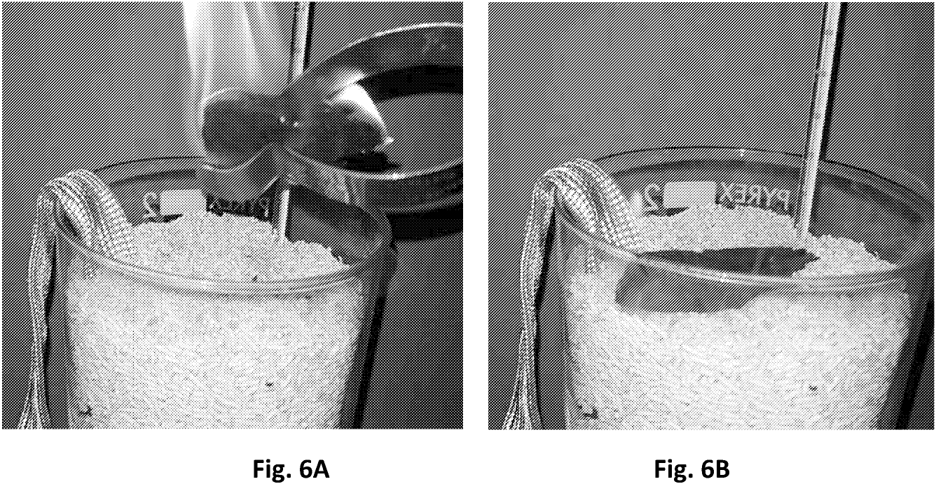

The fire suppressant properties of zeolite 5A can be demonstrated using simple laboratory tests. For example, as shown in FIG. 5, zeolite 5A granules were equilibrated with 1 atm CO₂ and then randomly distributed on a piece of burning wood (FIG. 5A), which was rapidly extinguished using zeolite of ⅒^{th} the weight on the burning wood (FIG. 5B). Similar results are shown in FIGS. 6A and B, in which an ember was immediately extinguished.

### Example 4

In the case of zeolite 5A, the zeolite has a density of around 0.7 g/ml, when cool, and it absorbs about 2.5 g of CO₂ per 100 g of zeolite, since atmospheric CO₂ has a partial pressure of about 0.3 torr. As the zeolite is heated, even to a modest temperature of 75° C., the absorbed CO₂ will be almost completely desorbed. The volume of this released CO₂ will be many times the volume of the zeolite, especially as the local temperature increases further. When heated by a hot ember (e.g., 300° C.), the zeolite would produce up to ^{~}20 x its volume of CO₂.

In practice this means that a 10 cm layer of roof cavity insulation will produce about a 1-2 m CO₂ layer in response to this heating, suppressing the heat source. In addition, once cooled the layer will re-absorb this amount of CO₂, enabling for further protection.

Using zeolite 5A, a roof cavity in Northern winters could theoretically absorb 2.5 g of CO₂ per 100 g and this would correspond to a CO₂ layer of ^{~}20 x this volume, or a layer of up to 2 m thick formed around the roof zeolite layer, within a burning roof cavity. Local heating due to embers or an electrical fault will also form this CO₂ region locally. There may be some advantage in mixing zeolite 5A with zeolite 3A granules to maintain low humidity.

The above analysis is provided by way of example only, and even larger volumes of CO₂ could be produced depending on the selected zeolite and the pressure/temperature conditions.

Other embodiments of the invention as described herein are defined in the following paragraphs:

1. A fire suppressant material for controlling or extinguishing a combustion process, the fire suppressant material comprising:
zeolite particles having an internal porous structure; and,
molecules of a fire extinguishing substance which are contained within the internal porous structure of the zeolite particles.

2. A fire suppressant material according to paragraph 1, wherein the molecules of the fire extinguishing substance are either carbon dioxide or water.

3. A fire suppressant material according to paragraph 1 or 2, wherein the pore size of the internal porous structure of the zeolite particles is selected to preferentially absorb carbon dioxide over nitrogen or oxygen.

4. A fire suppressant material according to any one of the preceding paragraphs, wherein pores of the internal porous structure are substantially consistent in size and shape.

5. A fire suppressant material according to any one of the preceding paragraphs, wherein the material is configured or adapted to activate and release the molecules of fire extinguishing substance upon absorption of heat generated in a combustion process.

6. A fire suppressant material according to paragraph 5 wherein the activation occurs at a temperature up to 80° C., or up to or around 200° C., or up to or around 300° C.

7. A fire suppressant material according to any one of the preceding paragraphs, wherein the material is configured or adapted (such as via storage of the zeolite under conditions to absorb the maximum CO₂, e.g., at 1 atmosphere of CO₂) such that activation upon absorption of heat results in release of a volume of molecules of fire extinguishing substance that is 100 - 200 times greater than the volume of the zeolite particles.

8. A fire suppressant material according to any one of the preceding paragraphs, wherein the material is configured to absorb CO₂ from the atmosphere and release this gas when exposed to heat, even up to modest levels of below 80° C.

9. A fire suppressant material according to any one of the preceding paragraphs wherein the material is capable of being regenerated on exposure to the atmosphere or an alternative source of the fire extinguishing molecules.

10. A fire suppressant material according to paragraph 9, wherein the material is able to absorb the fire extinguishing substance from the atmosphere or the source of the extinguishing molecules.

11. A fire suppressant material according to any one of paragraphs 1-10, wherein the zeolite particles comprise zeolite 5A particles and/or zeolite 3A or 4A particles.

12. A product for protecting a surface from a combustion process, the product comprising the fire suppressant material of any one of the preceding paragraphs.

13. A method for protecting a surface from a combustion process, the method comprising the steps of:
depositing a protective material onto the surface, the protective material comprising zeolite
particles with an internal porous structure having molecules of a fire extinguishing substance
contained in the internal porous structure of the zeolite particles.

14. A method for protecting a surface from a combustion process, the method comprising the step of: depositing a fire suppressant material according to any one of paragraphs 1-11 onto the surface.

15. A method as defined in paragraph 13 or paragraph 14, wherein the zeolite particles are dispersed in a solvent.

16. A method as defined in any one of paragraphs 13-15, wherein the fire suppressant material is designed or adapted to activate and release the extinguishing substance at up to 80° C., or up to 300° C.

17. A method as defined in any one of paragraphs 13-16, wherein the fire suppressant material is formulated to suppress ignition of fires or protect against ember attack.

18. A method of improving a fire suppressant system comprising the step of: adding the fire suppressant material of any one of paragraphs 1 to 10 to a direct fire suppressant system.

19. A method of suppressing a fire comprising the step of: applying the fire suppressant material of any one of paragraphs 1-10 directly to the fire.

20. A method of forming a barrier to fire comprising the step of: applying the fire suppressant material of any one of paragraphs 1-10 to the area where a barrier to fire is required.

Although the invention has been described with reference to specific examples, it will be appreciated by those skilled in the art that the invention may be embodied in many other forms in particular features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A fire suppressant material for controlling or extinguishing a combustion process, the fire suppressant material comprising:
zeolite particles having an internal porous structure; and,
molecules of a fire extinguishing substance which are contained within the internal porous structure of the zeolite particles.

2. A fire suppressant material according to claim 1, wherein the molecules of the fire extinguishing substance are either carbon dioxide or water.

3. A fire suppressant material according to claim 1 or 2, wherein the pore size of the internal porous structure of the zeolite particles is selected to preferentially absorb carbon dioxide over nitrogen or oxygen.

4. A fire suppressant material according to any one of the preceding claims, wherein pores of the internal porous structure are substantially consistent in size and shape.

5. A fire suppressant material according to any one of the preceding claims, wherein the material is configured or adapted to activate and release the molecules of fire extinguishing substance upon absorption of heat generated in a combustion process.

6. A fire suppressant material according to claim 5 wherein the activation occurs at a temperature up to 80° C., or up to or around 200° C., or up to or around 300° C.

7. A fire suppressant material according to any one of the preceding claims, wherein the material is configured or adapted (such as via storage of the zeolite under conditions to absorb the maximum CO₂, e.g., at 1 atmosphere of CO₂) such that activation upon absorption of heat results in release of a volume of molecules of fire extinguishing substance that is 100 - 200 times greater than the volume of the zeolite particles.

8. A fire suppressant material according to any one of the preceding claims, wherein the material is configured to absorb CO₂ from the atmosphere and release this gas when exposed to heat, e.g., up to 80° C.

9. A fire suppressant material according to any one of the preceding claims wherein the material is capable of being regenerated on exposure to the atmosphere or an alternative source of the fire extinguishing molecules.

10. A fire suppressant material according to claim 9, wherein the material is able to absorb the fire extinguishing substance from the atmosphere or the source of the extinguishing molecules.

11. A fire suppressant material according to any one of claims 1-10, wherein the zeolite particles comprise zeolite 5A particles and/or zeolite 3A or 4A particles.

12. A product for protecting a surface from a combustion process, the product comprising the fire suppressant material of any one of the preceding claims.

13. A method for protecting a surface from a combustion process, the method comprising the steps of:
depositing a protective material onto the surface, the protective material comprising zeolite particles with an internal porous structure having molecules of a fire extinguishing substance contained in the internal porous structure of the zeolite particles.

14. A method for protecting a surface from a combustion process, the method comprising the step of: depositing a fire suppressant material according to any one of claims 1-10 onto the surface.

15. A method as defined in claim 13 or claim 14, wherein the zeolite particles are dispersed in a solvent.

16. A method as defined in any one of claims 13-15, wherein the fire suppressant material is designed or adapted to activate and release the extinguishing substance at up to 80° C., or up to 300° C.

17. A method as defined in any one of claims 13-16, wherein the fire suppressant material is formulated to suppress ignition of fires or protect against ember attack.

18. A method of improving a fire suppressant system comprising the step of: adding the fire suppressant material of any one of claims 1 to 10 to a direct fire suppressant system.

19. A method of suppressing a fire comprising the step of: applying the fire suppressant material of any one of claims 1-10 directly to the fire.

20. A method of forming a barrier to fire comprising the step of: applying the fire suppressant material of any one of claims 1-10 to the area where a barrier to fire is required.
